(19) United States
(12) Patent Application Publication
(10) Pub. No.: US 2014/0082052 A1
(43) Pub. Date: Mar. 20, 2014

(54) DATA REDIRECTION SYSTEM AND METHOD FOR PROVIDING DATA REDIRECTION SERVICE

(71) Applicant: Electronics and Telecommunications Research Institute, Daejeon (KR)

(72) Inventors: Eun-Jung KWON, Daejeon (KR); Chang-Woo YOON, Daejeon (KR); Il-Hong SHIN, Daejeon (KR); Hyun-Woo LEE, Daejeon (KR); Won RYU, Daejeon (KR)

(73) Assignee: Electronics and Telecommunications Research Institute, Daejeon (KR)

(21) Appl. No.: 13/947,838

(22) Filed: Jul. 22, 2013

(30) Foreign Application Priority Data
Sep. 14, 2012 (KR) 10-2012-0102302

(51) Int. Cl. H04L 29/06

(52) U.S. Cl. CPC H04L 67/42
USPC 709/203

(57) ABSTRACT

A data redirection system and a method of providing a data redirection service are provided. The data redirection system includes a thin-client terminal configured to be connected to a local peripheral device and receive multimedia data from the local peripheral device; and a redirection server configured to be connected to the thin-client terminal via a network, receive the multimedia data from the thin-client terminal, execute the multimedia data in an application program and transmit an execution result screen displaying the result of the execution to the thin-client terminal.

### CROSS-REFERENCE TO RELATED APPLICATION(S)

This application claims priority from Korean Patent Application No. 10-2012-0102302, filed on Sep. 14, 2012, in the Korean Intellectual Property Office, the entire disclosure of which is incorporated herein by reference for all purposes.

### BACKGROUND

1. Field

The following description relates to a virtualization technology.

2. Description of the Related Art

Server virtualization is a method that enables a server to execute all services therein and to provide a client with only the results of the execution. According to server virtualization, the amount of computing resources used by the client and the manufacturing cost of a client can both be reduced because a client is simply configured to receive via a network an execution result screen displaying the result of execution of an application program by a server.

In the meantime, there are techniques to separate multiple sessions for multiple users, such as Server Based Computing (SBC) and Virtual Desktop Infrastructure (VDI). SBC is a method that separates terminal sessions by users while sharing a single operating system between users, and has been widely employed in architectures where various sessions are used. An example of SBC is a remote desktop connection through a personal computer (PC). On the contrary, in a VDI-based server system, an independent operating system is allocated whenever a client accesses a server. SBC and VDI are similar in that they both involve transmitting an execution result screen from a server to a client by means of a remote transmission technique.

The concept of sharing the physical resources (such as a hard disc) of a client or a remote printer between a plurality of users on a server has been suggested as an extension of the transmission of an execution result screen from a server to a client.

In addition, the demand for techniques for sharing the audio/video input/output devices of a client between multiple users on a server has steadily increased. For example, such techniques enable the external input device of a set-top box (STB), which is a type of low-end thin client equipped with a Universal Serial Bus (USB) external input device, to be driven by means of a virtual USB external input device generated in a server and also enable a video conference service to be provided in a cloud environment.

SBC provides different terminal sessions for different users while sharing a single operating system between the different users. However, in an SBC system architecture, a single operating system is shared for each session when virtualizing a USB external input device (such as a webcam) of a thin client in a server. Accordingly, it is difficult to distinguish the use of the USB external input device for one user session from the use of the USB external input device for another user session.

### SUMMARY

The following description relates to a data redirection system and a method of providing a data redirection service, in which the problems associated with the related art such as a server failing to process multimedia data separately for each session of a client can be addressed and various types of services can be provided in a cloud environment by allowing multimedia data of each client equipped with a Universal Serial Bus (USB) external input device to be processed by a server.

In one general aspect, a data redirection system includes: a thin-client terminal configured to be connected to a local peripheral device and receive multimedia data from the local peripheral device; and a redirection server configured to be connected to the thin-client terminal via a network, receive the multimedia data from the thin-client terminal, execute the multimedia data in an application program and transmit an execution result screen displaying the result of the execution to the thin-client terminal.

The local peripheral device may be a USB input device, such as a webcam, connected to the thin-client terminal via a USB interface. The thin-client terminal may be a set-top box (STB).

The thin-client terminal may include: a data capturing portion configured to capture multimedia data to be transmitted to the redirection server; a data compression portion configured to compress the captured multimedia data; and a data transmission portion configured to transmit the compressed multimedia data to the redirection server. The data capturing portion, the data compression portion and the data transmission portion may be provided at a user level. The data capturing portion may be further configured to capture multimedia data in accordance with output information that is obtained by a capability negotiation with the application program.

The redirection server may be further configured to generate a virtual peripheral driver for redirecting the local peripheral device to the redirection server at a user level and execute the multimedia data in the application program by means of the virtual peripheral driver.

The redirection server may be further configured to separate the multimedia data by sessions and execute the separated multimedia data in their respective application programs such that the separated multimedia data can be prevented from being accessed by other thin-client terminals via other sessions.

The redirection server may include: a data decoding unit configured to decode the multimedia data received from the thin-client terminal; a data filtering unit configured to generate a virtual peripheral driver for redirecting the local peripheral device to the redirection server and filter the decoded multimedia data by means of the virtual peripheral driver; an application program execution unit configured to execute the filtered multimedia data in the application program; and a transmission/reception unit configured to transmit an execution result screen displaying the result of the execution performed by the application program execution unit to the thin-client terminal.

In another aspect, a method of providing a data redirection service by redirecting a local peripheral device to a redirection server, includes: receiving multimedia data, which is input to a thin-client terminal from the local peripheral device, from the thin-client terminal; executing the multimedia data in an application program; and transmitting an execution result screen displaying the result of the execution to the thin-client terminal.

In another aspect, a method for a thin-client terminal to receive a data redirection service from a redirection server, includes: establishing a connection to a local peripheral device, receiving multimedia data from the local peripheral device and capturing the received multimedia data; compressing the captured multimedia data and transmitting the compressed multimedia data to the redirection server; and receiving an execution result screen displaying the result of execution of the compressed multimedia data from the redirection server.

Other features and aspects may be apparent from the following detailed description, the drawings, and the claims.

### BRIEF DESCRIPTION OF THE DRAWINGS

FIG. 1 is a block diagram illustrating an example of a data redirection system.

FIG. 2 is a detailed block diagram illustrating an example of a thin-client terminal.

FIG. 3 is a detailed block diagram of an example of a redirection server.

FIG. 4 is a flowchart illustrating an example of a virtualization process.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and constructions may be omitted for increased clarity and conciseness.

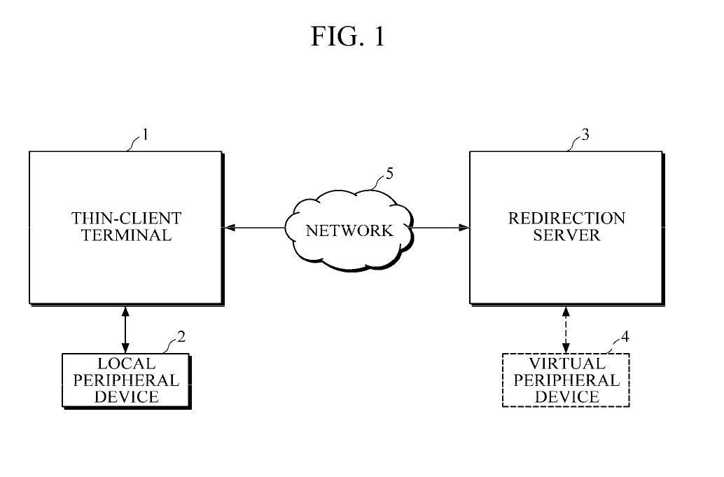

FIG. 1 is a block diagram illustrating an example of a data redirection system.

Referring to FIG. 1, the data redirection system includes a thin-client terminal 1 (hereinafter, referred to as the client 1), a local peripheral device 2, a redirection server 3 (hereinafter, referred to as the server 3), and a network 5.

In the data redirection system, the client 1 is configured to have as simple a structure as possible, and all relevant information and functions reside in the server 3. A thin client technology is applied the data redirection system so that the data redirection system executes application programs in the server 3, simplifies the hardware structure and the software resources of the client 1 as much as possible, and does not store information in the client 1. By using the thin client technology, it is possible to reduce the manufacturing and maintenance costs of the client 1 and facilitate a backup process.

It is desirable that the client 1 is equipped with a minimum amount of resources and is provided with various services by maximizing the use of the resources of the server 3. It is typical that the server 3 transmits a text-type remote screen including not much motion graphics to the client 1. On the other hand, it is complicated for the server 3 to execute multimedia data received from the local peripheral device 2, which is connected to the client 1, and to provide an execution result screen displaying the result of the execution to the client 1 because no system infrastructure with an operating system for executing the multimedia data from the local peripheral device 2 in the server 3 for each session of the client 2 is supported. A data redirection system and a method of providing a data redirection service, in which the server 3 can process multimedia data of the client 1 connected to the local peripheral device 2 while addressing the problems associated with the related art such as a server failing to process multimedia data separately for each session of a client, will hereinafter be described.

The client 1 may communicate with the server 3 via a virtual channel to the network 5 by means of a remote user interface protocol. Alternately, the client 1 may communicate with the server via the network 5 by means of Transmission Control Protocol/Internet Protocol (TCP/IP). In an example, the remote user interface protocol may be a Remote Desktop Protocol (RDP). It is assumed that the client 1 uses RDP, even though it is obvious that various other protocols such as Independent Computing Architecture (ICA), eXtended Remote Technology (XRT), Virtual Device Interface (VDI), etc., can be used as the remote user interface protocol. In an example, the client 1 may be a set-top box (STB).

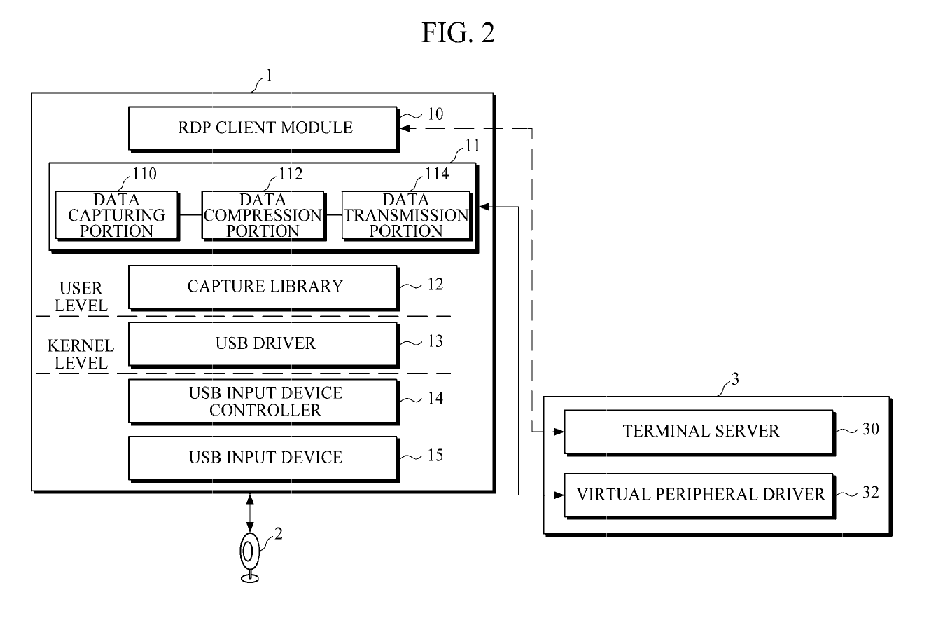

The client 1 is connected to the local peripheral device 2. In an example, the local peripheral device 2 may be a Universal Serial Bus (USB) external input device connected to the client 1 via a USB interface. In another example, the local peripheral device 2 may be a printer, a USB key, a digital camera, a digital versatile disc (DVD) player, or a webcam. The client 1 transmits multimedia data generated by the local peripheral device 2 to the server 3. The multimedia data includes video data and audio data. The client 1 may perform data compression on the multimedia data before the transmission of the multimedia data to the server 3. The structure of the client 2 will be described later with reference to FIG. 2.

The server 3, which is located in a remote area, is session-connected to the client 1 via the network 5. During the session connection to the client 1, the server 3 generates a virtual peripheral device 4 by redirecting the local peripheral device 2 to the server 3. The server 3 has an application program for executing the multimedia data transmitted by the client 1. In an example, the application program may be a video- or audio-player program.

More specifically, the server 3 may redirect the local peripheral device 2 thereto at a user level, rather than at a kernel level. In a user mode where a user level is accessed, unlike in a kernel mode where a kernel level can be accessed, instructions and data can be used without the need to access the kernel level. Accordingly, in the user mode, the server 3 does not need to emulate the USB driver at the kernel level to redirect the local peripheral device 2 to the server 3.

The server 3, instead of the client 1, logically separates the multimedia data of the local peripheral device 2 by sessions such that the multimedia data can be prevented from being accessed through other sessions than their respective ones. Accordingly, it is possible to precisely provide a cloud-based multimedia service to each client. The structure of the server 3 will be described later with reference to FIG. 2.

In an example, the data redirection system may be used in a karaoke or for a video conference. In another example, the data redirection system may be used to provide bidirectional services such as Internet Protocol Television (IPTV) services, etc. In the data redirection system, multimedia is executed in the application program of the server 3. Accordingly, it is possible to simplify the hardware structure and software resources of the client 1, reduce the manufacturing and maintenance costs of the client 1, and facilitate a data backup process.

FIG. 2 is a detailed block diagram illustrating an example of the client 1.

Referring to FIG. 2, the client 1 includes a data processing unit 11. The data processing unit 11 may include a data capturing portion 110, a data compression portion 112 and a data transmission portion 114.

The client 1 also includes an RDP client module 10, a capture library 12, a USB driver 13, a USB input device controller 14, and a USB input device 15. The client 1 accesses a terminal server 30 in the server 3 via the RDP client module 10 by means of RDP and is thus allocated a session. In response to the client 1 accessing the terminal server 30, the terminal server 30 generates a new session. In a case in which more than a predetermined amount of time passes without any communication with the client 1, the terminal server 30 determines that the client 1 is no longer connected, and deletes the generated session.

The client 1 may be connected to the local peripheral device 2 (for example, a webcam) via the USB input device 15. In response to the local peripheral device 2 operating, the data capturing portion 110 captures multimedia data generated by the local peripheral device 2. The USB input device controller 14 controls the USB input device 15.

The data capturing portion 110 may communicate with the server 3 to capture multimedia data. In an example, the client 1 may receive local peripheral device processing setting information of an application program that is being run in the server 3 when the client 1 is connected to the server 3, may define output information such as resolution, output format, etc., based on the local peripheral device processing setting information, and may capture multimedia data in accordance with the defined output information.

The data compression portion 112 compresses and thus encodes the multimedia data captured by the data capturing portion 110. The data compression portion 112 may separate audio data and video data from the captured multimedia data and may capture the audio data and the video data separately. The multimedia data captured by the client 1 may be multimedia data generated by a low-end local peripheral device 2 that generally does not support compression. The data compression portion 112 may improve the upstream transmission efficiency for data transmitted from the client 1 to the server 3 by compressing the multimedia data captured by the client 1. In an example, the data compression portion 112 may compress captured audio and/or video data into a format such as JPEG, GIF, MPEG, etc.

The data transmission portion 114 transmits the multimedia data compressed by the data compression portion 112 to the server 3. In an example, the data transmission portion 114 may transmit compressed multimedia data to the server via an RDP virtual channel. In another example, the data transmission portion 114 may transmit compressed multimedia data to the server 3 in the form of a TCP/IP packet without the use of an RDP virtual channel.

In an example, the data capturing portion 110, the data compression portion 112 and the data transmission portion of the data processing unit 11 may be provided at a user level. In this example, the data capturing portion 110 may capture audio and video data by using the capture library 12, which includes an audio library and a video library.

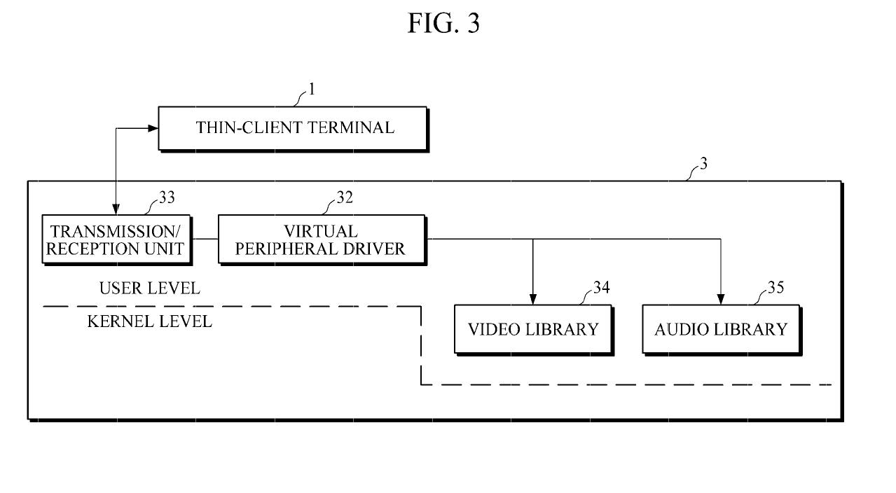

FIG. 3 is a detailed block diagram illustrating an example of the server 3.

Referring to FIG. 3, the server 3 may redirect the local peripheral device 2 thereto at a user level, rather than at a kernel level. The server 33 may include a transmission/reception unit 33, a virtual peripheral driver 32, a video library 34, and an audio library 35. The transmission/reception unit 33 receives multimedia data from the client 1, and transmits the result of executing the received multimedia data in an application program installed in the server 3 to the client 1. In an example, the result of executing the received multimedia data may be transmitted to the client 1 in the form of graphic data.

The virtual peripheral driver 32 filters and renders the multimedia data received from the client 1 via the transmission/reception unit 33, and executes the rendered multimedia data in the application program installed in the server 3. The virtual peripheral driver 32 may use the video library 34 and the audio library 35 to perform filtering and rendering.

The server 3 may receive multimedia data, which is captured, compressed and transmitted by the client 1, may decode the received multimedia data, and may execute the decoded multimedia data in the application installed therein.

More specifically, the virtual peripheral driver 32 of the server may perform source filtering to distinguish data transmitted by the client 1 from other data in a user-level programming environment. For example, in response to the operating system of the server 3 being Microsoft Windows, the virtual peripheral driver 32 may perform directX source filtering. That is, the virtual peripheral driver 32 may generate an exclusive filter for distinguishing packets transmitted by the client 1 from other data, and may filter multimedia data received from the client 1 by using the generated exclusive filter. Then, the virtual peripheral driver 32 may perform format conversion on the filtered multimedia data, thereby obtaining format information of the filtered multimedia data. The virtual peripheral driver 32 may prepare for rendering based on the obtained format information or an initial default value. The virtual peripheral driver 32 may perform decoding on the filtered multimedia data to restore the original compressed multimedia data transmitted by the client 1.

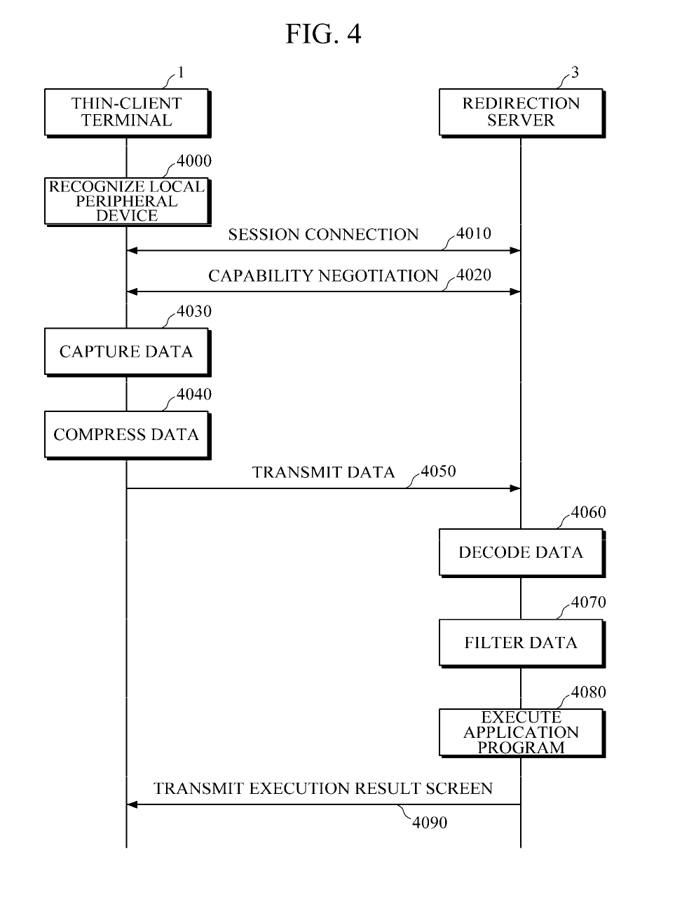

FIG. 4 is a flowchart illustrating an example of a virtualization process.

Referring to FIGS. 1 and 4, the client 1 recognizes the local peripheral device 2 (for example, a webcam) by means of, for example, a USB Interface (4000). In response to the USB driver of the client 1 detecting the local peripheral device 2, the client 1 recognizes the local peripheral device 2 at a user level. In order for the server 3 to redirect the local peripheral device 2 thereto, the client 1 is session-connected to the server 3 (4010).

The client 1 performs a capability negotiation with an application program (for example, a video conference program) of the server 3 (4020) so as to define output information (for example, resolution, frame per second (FPS), etc.) of multimedia data. As a result of operation 4020, the client 1 may easily communicate with the server 3.

The client 1 captures multimedia data of the local peripheral device 2 (4030) in accordance with the output information obtained by a negotiation with the server 3, and performs compression encoding on the captured multimedia data (4040). In an example, in response to a JPEG library already being installed in the kernel of the client 1, the captured multimedia data may be encoded in a JPEG format. In this manner, it is possible to improve transmission efficiency and reduce any transmission delays.

The client 1 transmits the compressed multimedia data to the server 3 (4050). In an example, the client 1 may use TCP/IP or an RDP virtual channel to transmit the compressed multimedia data to the server 3.

In response to the compressed multimedia data being received from the client 1, the server 3 decodes the received multimedia data (4060) to restore the original multimedia data. In an example, in response to the received multimedia data being JPEG-encoded multimedia data, the client 1 may perform JPEG decoding on the received multimedia data.

The server 3 filters the decoded multimedia data in the form of bitmap data (4070) by means of a virtual peripheral driver installed therein, and executes the filtered multimedia data in the application program (e.g., a video conference program) thereof (4080). The server 3 transmits the result of executing the filtered multimedia data to the client 1 by means of, for example, RDP (4090).

The virtualization process illustrated in FIG. 4 may be used to provide high-efficiency performance with the use of a low-end client 1. According to the example illustrated in FIG. 4, the server 3 may process audio and/or video data separately for each session in a cloud environment without the need to emulate a USB driver at a kernel level. In addition, it is possible to efficiently manage hardware resources or computing power for the client 1 by executing a multimedia application program such as a karaoke or video conference service in the server 3 by means of remote audio/video data processing.

According to embodiments, multimedia data of a local peripheral device (for example, a USB external input device) connected to a client is redirected to a redirection server at a user level, rather than at a kernel level of a redirection server. Accordingly, an execution result screen displaying the result of executing multimedia data can be provided to a client without the need to perform complicated processes such as a virtual USB emulation at the kernel level.

In addition, according to embodiments, a redirection server separates multimedia data by sessions, and executes the multimedia data in an application program separately for each of the sessions. Accordingly, it is possible to prevent the multimedia data from being accessed via other sessions. Thus, the redirection server does not need to allocate an independent operating system to each client and can precisely provide a cloud-based multimedia service to each client.

According to embodiments, it is possible to provide efficient data redirection services that can keep up with the ever-increasing usage of IPTV services and the widespread availability of IPTV services in the form of bidirectional services. That is, it is possible to provide data redirection services that can be applied to a server or an STB providing or being provided with IPTV services in a cloud environment.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A data redirection system, comprising:
a thin-client terminal configured to be connected to a local peripheral device and receive multimedia data from the local peripheral device; and
a redirection server configured to be connected to the thin-client terminal via a network, receive the multimedia data from the thin-client terminal, execute the multimedia data in an application program and transmit an execution result screen displaying the result of the execution to the thin-client terminal.

2. The data redirection system of claim 1, wherein the local peripheral device is a Universal Serial Bus (USB) input device connected to the thin-client terminal via a USB interface.

3. The data redirection system of claim 2, wherein the local peripheral device is one of a printer, a USB key, a digital camera, a digital versatile disc (DVD) player and a webcam.

4. The data redirection system of claim 1, wherein the thin-client terminal is a set-top box (STB).

5. The data redirection system of claim 1, wherein the thin-client terminal comprises:
a data capturing portion configured to capture multimedia data to be transmitted to the redirection server;
a data compression portion configured to compress the captured multimedia data; and
a data transmission portion configured to transmit the compressed multimedia data to the redirection server.

6. The data redirection system of claim 5, wherein the data capturing portion, the data compression portion and the data transmission portion are provided at a user level.

7. The data redirection system of claim 5, wherein the data capturing portion is further configured to capture multimedia data in accordance with output information that is obtained by a capability negotiation with the application program.

8. The data redirection system of claim 1, wherein the redirection server is further configured to generate a virtual peripheral driver for redirecting the local peripheral device to the redirection server at a user level and execute the multimedia data in the application program by means of the virtual peripheral driver.

9. The data redirection system of claim 1, wherein the redirection server is further configured to separate the multimedia data by sessions and execute the separated multimedia data in their respective application programs such that the separated multimedia data can be prevented from being accessed by other thin-client terminals via other sessions.

10. The data redirection system of claim 1, wherein the redirection server comprises:
a data decoding unit configured to decode the multimedia data received from the thin-client terminal;
a data filtering unit configured to generate a virtual peripheral driver for redirecting the local peripheral device to the redirection server and filter the decoded multimedia data by means of the virtual peripheral driver;
an application program execution unit configured to execute the filtered multimedia data in the application program; and
a transmission/reception unit configured to transmit an execution result screen displaying the result of the execution performed by the application program execution unit to the thin-client terminal.

11. A method of providing a data redirection service by redirecting a local peripheral device to a redirection server, the method comprising:
receiving multimedia data, which is input to a thin-client terminal from the local peripheral device, from the thin-client terminal;
executing the multimedia data in an application program; and
transmitting an execution result screen displaying the result of the execution to the thin-client terminal.

12. The method of claim 11, wherein the executing comprises generating a virtual peripheral driver for redirecting the local peripheral device to the redirection server at a user level and executing the multimedia data in the application program by means of the virtual peripheral driver.

13. The method of claim 11, wherein the executing comprises separating the multimedia data by sessions and executing the separated multimedia data in their respective application programs such that the separated multimedia data can be prevented from being accessed by other thin-client terminals via other sessions.

14. The method of claim 11, wherein the executing comprises:
decoding the multimedia data;
generating a virtual peripheral driver for redirecting the local peripheral device to the redirection server and filtering the decoded multimedia data by means of the virtual peripheral driver; and
executing the filtered multimedia data in the application program.

15. A method for a thin-client terminal to receive a data redirection service from a redirection server, the method comprising:
establishing a connection to a local peripheral device, receiving multimedia data from the local peripheral device and capturing the received multimedia data;
compressing the captured multimedia data and transmitting the compressed multimedia data to the redirection server; and
receiving an execution result screen displaying the result of execution of the compressed multimedia data from the redirection server.

16. The method of claim 15, wherein the capturing and the transmitting are performed at a user level.

17. The method of claim 16, wherein the capturing comprises capturing the received multimedia data in accordance with output information that is obtained by a capability negotiation with an application program in the redirection server for executing the corresponding multimedia data.
